(19) United States
(12) Patent Application Publication
(10) Pub. No.: US 2026/0160570 A1
(43) Pub. Date: Jun. 11, 2026

(54) METHOD AND DEVICE FOR RECOMMENDING ROUTE

(71) Applicants: Hyundai Motor Company, Seoul (KR); Kia Corporation, Seoul (KR)

(72) Inventor: Hyunseon Chae, Hwaseong-si (KR)

(21) Appl. No.: 19/399,961

(22) Filed: Nov. 25, 2025

(30) Foreign Application Priority Data
Dec. 10, 2024 (KR) 10-2024-0182222

(51) Int. Cl. G01C 21/36; B60W 40/08; B60W 50/14; G06V 20/59; G06V 40/16; G06V 40/18

(52) U.S. Cl. CPC G01C 21/3617; B60W 40/08; B60W 50/14; G06V 20/597; G06V 40/178; G06V 40/18; B60W 2040/0827; B60W 2040/0872; B60W 2050/146; B60W 2420/403; B60W 2540/221; B60W 2540/225; B60W 2540/229

(57) ABSTRACT

A route recommending method and device is provided, and may include: transmitting position information of a vehicle to a remote server; receiving first remote data on an activation state of route recommendation, second remote data on a delivery route, third remote data on a delivery stage, and fourth remote data on a quantity and weight of goods; receiving first local data on the activation state and second local data on biometric information of a driver; determining whether the first remote data or the first local data indicates activation of the route recommendation; when the first remote or local data indicates activation of route recommendation, calculating fatigue of the driver based on at least one of the second local data, the second remote data, and the third remote data; and generating and displaying a recommended route obtained by changing the second remote data.

### CROSS-REFERENCE TO RELATED APPLICATIONS

This application claims priority to and the benefit of Korean Patent Application No. 10-2024-0182222 filed with the Korean Intellectual Property Office on Dec. 10, 2024, the entire contents of which are incorporated herein by reference.

### TECHNICAL FIELD

The present disclosure relates to a route recommending method and device, and particularly relates to a route recommending method and device for monitoring a state of a driver and recommending a route considering resting of the driver.

### BACKGROUND

As demand for delivery service increases, the delivery industry is focusing on providing services that maximize efficiency and speed. However, during this process, accidents caused by overwork among delivery drivers continue to occur due to long driving hours and high work intensity. Currently, there is no additional system that takes the fatigue level of the driver into account, so the delivery drivers themselves must take measures such as taking appropriate resting.

### SUMMARY

The present disclosure attempts to provide a route recommending method and device for monitoring a state of a driver in real time, and providing a route recommendation considering a relaxing location.

An embodiment of the present disclosure provides a route recommending method implemented in a vehicle, and performed by a computing device including a processor and a communication interface including: transmitting, by the processor, position information of the vehicle obtained from a position detecting device installed in the vehicle to a remote server through the communication interface; receiving, by the processor, first remote data on an activation state of route recommendation, second remote data on a delivery route of goods, third remote data on a delivery stage of the goods, and fourth remote data on a quantity and weight of delivery goods from the remote server through the communication interface; receiving, by the processor, first local data on the activation state of route recommendation and second local data on biometric information of a driver through an internal network of the vehicle; determining, by the processor, whether a value of the first remote data or the first local data indicates activation of the route recommend; when the value of the first remote data or the first local data is determined to indicate the activation of the route recommendation, calculating, by the processor, fatigue of the driver based on at least one of the second local data, the second remote data, and the third remote data; generating, by the processor, a recommended route obtained by changing the second remote data to induce resting of the driver according to a level of the fatigue; and displaying, by the processor, the recommended route on a display device in the vehicle.

In several embodiments, the second local data may include biometric data measured by a smart wheel installed in the vehicle and having at least one sensor measuring the biometric information, and the calculating of fatigue of the driver includes calculating the fatigue level of the driver as high when a change of at least one of heart rate, skin conductance, body temperature, and pressure of grabbing the smart wheel measured by the smart wheel is greater than a predetermined reference in the second local data.

In several embodiments, the second local data may include eye blinking capture data measured by a camera installed in the vehicle, and the calculating of fatigue of the driver includes calculating the fatigue level of the driver as high when the number of eye blinking measured by the camera increases to be greater than a predetermined reference compared to an average value in the second local data.

In several embodiments, the method may further include receiving, by the processor, fifth remote data on an age of the driver of the vehicle from the remote server through the communication interface, wherein the calculating of fatigue of the driver includes calculating the fatigue of the driver by reflecting the fifth remote data as a weight to the second local data when calculating the fatigue of the driver based on the second local data.

In several embodiments, the calculating of fatigue of the driver may include calculating the fatigue of the driver by reflecting the third remote data as a weight to the second local data when calculating the fatigue of the driver based on the second local data.

In several embodiments, the calculating of fatigue of the driver may include calculating the fatigue of the driver by reflecting the fourth remote data as a weight to the second local data when calculating the fatigue of the driver based on the second local data.

In several embodiments, the calculating of fatigue of the driver may include calculating first fatigue based on the second local data; calculating second fatigue based on the third remote data; calculating third fatigue based on the fourth remote data; and calculating the highest of the first fatigue, the second fatigue, and the third fatigue as final fatigue.

In several embodiments, the generating of a recommended route may include searching for a resting point in a predetermined radius at a current position of the vehicle when the fatigue level is calculated as high; and generating the recommended route by adding the resting point to the delivery route of the second remote data.

In several embodiments, the route recommending method may further include when the fatigue level is calculated as high, determining, by the processor, fatigue intensity based on first fatigue calculated based on the second local data, second fatigue calculated based on the third remote data, and the fourth remote data, wherein the generating of a recommended route may include generating the recommended route by changing the number of the resting points according to the fatigue intensity.

In several embodiments, the method may further include receiving, by the processor, a compulsory resting instruction for instructing a compulsory resting from the remote server through the communication interface; and generating, by the processor, the recommended route regardless of the fatigue of the driver in response to the compulsory resting instruction.

Another embodiment of the present disclosure provides a route recommending device implemented in a vehicle including: a communication interface; at least one non-transitory computer-readable medium including instructions; and at least one processor for executing the instructions and performing operations, wherein the operation includes transmitting position information of the vehicle obtained from a position detecting device installed in the vehicle to a remote server through the communication interface, receiving first remote data on an activation state of route recommendation, second remote data on a delivery route of goods, third remote data on a delivery stage of the goods, and fourth remote data on the number and weight of the delivery goods from the remote server through the communication interface, receiving first local data on the activation state of route recommendation and second local data on biometric information of the driver through the vehicle, determining whether a value of the first remote data or the first local data indicates the activation of route recommendation, when the value of the first remote data or the first local data is determined to indicate the activation of the route recommend, calculating fatigue of the driver based on at least one of the second local data, the second remote data, and the third remote data, generating a recommended route obtained by changing the second remote data to induce resting of the driver according to the fatigue level, and displaying the recommended route on a display device in the vehicle.

In several embodiments, the second local data may include biometric data measured by a smart wheel installed in the vehicle and having at least one sensor measuring the biometric information, and the calculating of fatigue of the driver may include calculating the fatigue level of the driver as high when a change of at least one of heart rate, skin conductance, body temperature, and pressure of grabbing the smart wheel measured by the smart wheel is greater than a predetermined reference in the second local data.

The second local data may include eye blinking capture data measured by a camera installed in the vehicle, and the calculating of fatigue of the driver may include calculating the fatigue level of the driver as high when the number of eye blinking measured by the camera increases to be greater than a predetermined reference compared to an average value in the second local data.

In several embodiments, the operation may further include receiving fifth remote data on an age of the driver of the vehicle from the remote server through the communication interface, and the calculating of fatigue of the driver may include calculating the fatigue of the driver by reflecting the fifth remote data as a weight to the second local data when calculating the fatigue of the driver based on the second local data.

In several embodiments, the calculating of fatigue of the driver may include calculating the fatigue of the driver by reflecting the third remote data as a weight to the second local data when calculating the fatigue of the driver based on the second local data.

In several embodiments, the calculating of fatigue of the driver may include calculating the fatigue of the driver by reflecting the fourth remote data as a weight to the second local data when calculating the fatigue of the driver based on the second local data.

In several embodiments, the calculating of fatigue of the driver may include calculating first fatigue based on the second local data; calculating second fatigue based on the third remote data; calculating third fatigue based on the fourth remote data; and calculating the highest of the first fatigue, the second fatigue, and the third fatigue as final fatigue.

In several embodiments, the generating of a recommended route may include searching for a resting point in a predetermined radius at a current position of the vehicle when the fatigue level is calculated as high; and generating the recommended route by adding the resting point to the delivery route of the second remote data.

In several embodiments, the operation may further include, when the fatigue level is calculated as high, determining fatigue intensity based on first fatigue calculated based on the second local data, second fatigue calculated based on the third remote data, and the fourth remote data, and the generating of a recommended route may include generating the recommended route by changing the number of the resting points according to the fatigue intensity.

Another embodiment of the present disclosure provides a computer-readable medium as at least one non-transitory computer-readable medium including instructions executable by a computing device including a communication interface, wherein the instructions allow the computing device to perform operations when executed by at least one processor of the computing device, and the operations include transmitting position information of the vehicle obtained from a position detecting device installed in the vehicle to a remote server through the communication interface, receiving first remote data on an activation state of route recommendation, second remote data on a delivery route of goods, third remote data on a delivery stage of the goods, and fourth remote data on the number and weight of delivery goods from the remote server through the communication interface, receiving first local data on the activation state of route recommendation and second local data on biometric information of the driver through an internal network of the vehicle, determining whether a value of the first remote data or the first local data indicates the activation of route recommendation, when a value of the first remote data or the first local data is determined to indicate the activation of route recommendation, calculating fatigue of the driver based on at least one of the second local data, the second remote data, and the third remote data, generating a recommended route generated by changing the second remote data to induce resting of the driver according to the fatigue level, and displaying the recommended route on a display device in the vehicle.

### BRIEF DESCRIPTION OF THE DRAWINGS

FIG. 1 shows a route recommending device according to an embodiment.

FIG. 2 shows an implemented example of a route recommending device according to an embodiment.

FIG. 3 shows an implemented example of a route recommending device according to an embodiment.

FIG. 4 shows a route recommending method according to an embodiment.

FIG. 5 shows an implemented example of a route recommending device according to an embodiment.

FIG. 6 shows a computing device according to an embodiment.

### DETAILED DESCRIPTION OF ILLUSTRATIVE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive, and like reference numerals designate like elements throughout the specification.

Unless explicitly described to the contrary, the word “comprise”, and variations such as “comprises” or “comprising”, will be understood to imply the inclusion of stated elements but not the exclusion of any other elements. Terms including ordinal numbers such as first, second, and the like, will be used only to describe various components, and are not to be interpreted as limiting these components. The terms may be only used to differentiate one component from others.

The terms such as “. . . part,” “. . . portion,” “ . . . er/or,” or “module” disclosed in the present specification may mean a unit that may process at least one function or operation described in this specification, and this may be implemented by hardware, software, or a combination thereof. At least some configurations or functions in the method and device for recommending a route according to embodiments may be implemented as a program or software, and the program or software may be stored in a computer-readable medium.

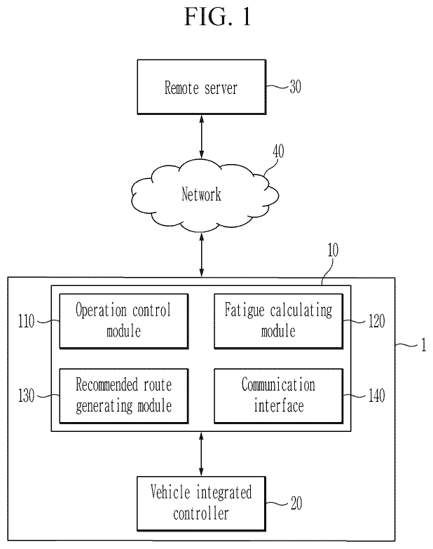

FIG. 1 shows a route recommending device according to an embodiment.

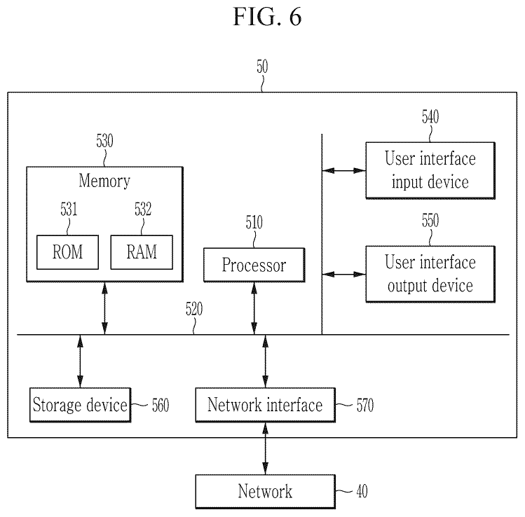

Referring to FIG. 1, the route recommending device 10 may be implemented as a computing device including a processor and a memory. For example, the route recommending device 10 may be implemented as a computing device 50 to be described with reference to FIG. 6. The computing device 50 may be implemented into a vehicle 1, for example, it may be implemented as a controller mounted in the vehicle 1. The processor may correspond to a processor 510 of the computing device 50, and the memory may correspond to a memory 520 of the computing device 50. In several embodiments, the route recommending device 10 may include at least one non-transitory computer-readable medium including instructions and at least one processor for performing operations executing the instructions. The operations may include configurations, functions, and stages of the route recommending method and device according to embodiments described in the present specification. In the present specification, a term “module” is used to logically distinguish the operations performed by the route recommending method and device according to embodiments.

The route recommending device 10 may be implemented in the vehicle 1. The route recommending device 10 may transmit and receive data to/from a vehicle integrated controller 20 implemented in the vehicle 1 through an internal network. In several embodiments, the internal network may include a controller area network (CAN), a local interconnect network (LIN), and an automotive ethernet. The vehicle integrated controller 20 may manage various systems installed in the vehicle 1 and may control them in an integrated way.

The route recommending device 10 may transmit and receive data to/from a remote server 30 through a network 40. The remote server 30 may represent a server owned or serviced by a transportation provider. For example, the vehicle 1 may be a goods delivery vehicle, may communicate with the remote server 30, and may receive various types of information including a goods delivery route, a goods delivery schedule, and a goods delivery stage. The vehicle 1 may provide various types of information on a present condition of goods delivery and the vehicle 1 to the remote server 30. The network 40 may include, for example, a wireless network that may be realized as a cellular network or a WiFi network.

Previously, there was no system for detecting the fatigue of the driver, so drivers had to take appropriate measures such as recognizing the need for relaxation, finding a resting space, and parking the car. In addition, since the routes provided by the logistics system do not take the fatigue of the driver state into account, there was a problem that directly led to overwork and the risk of traffic accidents when there was no relaxing space in the route. To solve this problem, the route recommending device 10 may reduce the risk of accidents caused by overwork and support appropriate responses according to a function of monitoring the state of the driver and adjusting the route. In detail, the route recommending device 10 may include an operation control module 110, a fatigue calculating module 120, a recommended route generating module 130, and a communication interface 140.

The operation control module 110 may control a route recommending operation. The operation control module 110 may transmit position information of the vehicle 1 obtained from a position detecting device (not shown) installed in the vehicle 1 to the remote server 30 using the communication interface 140. In several embodiments, the position detecting device may include a global positioning system (GPS) device. However, a method for obtaining position information is not limited to using a GPS device. The position information may be obtained through shared position information from another vehicle through, for example, vehicle-to-everything (V2X) communication.

The operation control module 110 may receive remote data from the remote server 30 through the communication interface 140. The remote data may include first remote data, second remote data, third remote data, and fourth remote data.

The first remote data may relate to whether the route recommendation is activated, and may include a value indicating activation of the route recommendation or a value indicating deactivation of the route recommendation. These values may be implemented as, for example, Boolean-type values, integer-type values, real number-type values, enumerated-type values, string values, bit flag values, etc. The second remote data may relate to a delivery route of goods and may include values that quantify and express various factors relating to the delivery route. The second remote data may include, for example, values expressed as quantifiable values relating to coordinates of origin and destination, coordinates of intermediate stopovers, types of roads, estimated travel time, departure and arrival times, traffic conditions, and road conditions. The third remote data may relate to the delivery stage of goods and may include values that quantify and express various factors relating to the delivery stage. The third remote data may include information expressed as quantifiable values, such as, for example, goods departure time, delivery vehicle information, driver information, current delivery position, current delivery status, goods arrival time, and recipient information. The fourth remote data may include values regarding the quantity and weight of delivery goods.

The operation control module 110 may receive first local data and second local data from the vehicle integrated controller 20 through the internal network of the vehicle 1. The first local data may relate to whether activation of route recommendation is enabled. The operation control module 110 may receive the first remote data on whether the route recommendation is activated from the remote server 30, but may also receive the first local data on whether the route recommendation is activated from the vehicle integrated controller 20. As with the first remote data, these values may be implemented as Boolean-type values, integer-type values, real number-type values, enumerated-type values, string values, bit flag values, etc. The second local data may be biometric information of the driver. The second local data may include driver biometric information acquired by various sensors or measuring devices, for example, a smart wheel. Non-limiting examples of biometric information may include heart rates, heart rate variability, respiration rates, skin conductance, body temperatures, an eye blinking frequency, blood pressures, blood oxygen saturation, brain waves, and stress indexes, and this information may be acquired as numeric data or array data. For another example, when the measuring device provides a result obtained by converting biometric information into fatigue representing values, the second local data may include numerical fatigue values.

The operation control module 110 may determine whether the value of the first remote data or the first local data indicates activation of the route recommendation. When the value of the first remote data or the first local data is determined to indicate the activation of the route recommendation, the operation control module 110 may allow the fatigue calculating module 120 to calculate the fatigue of the driver based on at least one of the second local data, the second remote data, and the third remote data.

In several embodiments, the second local data may include biometric data measured by a smart wheel mounted on the vehicle 1 and having at least one sensor for measuring biometric information. Regarding calculating the fatigue of the driver, the fatigue calculating module 120 may calculate the fatigue level of the driver as high when the change of at least one of the heart rate, skin conductance, body temperature, and pressure of grabbing the smart wheel, which are measured by the smart wheel, in the second local data exceeds a predetermined reference. In several embodiments, when the fatigue value is calculated from the smart wheel, and the change in the fatigue value exceeds a predetermined reference, the fatigue level of the driver may be calculated as high. For example, when the fatigue value calculated from the smart wheel is 30% higher than the average, the fatigue calculating module 120 may calculate the fatigue level of the driver as high.

In several embodiments, the second local data may include eye blinking capture data measured by a camera mounted inside the vehicle. Regarding calculating the fatigue of the driver, the fatigue calculating module 120 may calculate the fatigue level of the driver as high when the number of eye blinks measured by the camera in the second local data increases to exceed a predetermined reference compared to the average value. For example, when the eye blinking increases by more than 30% compared to the average, the fatigue calculating module 120 may calculate the fatigue level of the driver as high.

In several embodiments, the fatigue calculating module 120 may additionally receive fifth remote data on the age of the driver of the vehicle from the remote server 30 through the communication interface 140. Regarding calculating the fatigue of the driver, the fatigue calculating module 120 may calculate the fatigue of the driver by reflecting the fifth remote data as a weight to the second local data when calculating the fatigue of the driver based on the second local data. For example, when the driver's age is higher than the reference age (e.g., 35 years old), the condition that the fatigue value calculated from the smart wheel is 30% or more compared to the average as a reference for calculating the fatigue level of the driver as high may be changed to the condition that the fatigue value calculated from the smart wheel is 20% or more compared to the average. For another example, when the driver's age is higher than the reference age (e.g., 35 years old), the condition that eye blinking increases by more than 30% compared to the average as a reference for calculating the fatigue level of the driver as high may be changed to the condition that eye blinking increases by more than 20% compared to the average.

In several embodiments, the fatigue calculating module 120 may calculate the fatigue of the driver by reflecting the third remote data as a weight to the second local data when calculating the fatigue of the driver based on the second local data. For example, when the current delivery position is near a delivery address, the condition that the fatigue value calculated from the smart wheel is 30% or more compared to the average as the reference for calculating the fatigue level of the driver as high may be changed to the condition that the fatigue value calculated from the smart wheel is 60% or more compared to the average in order to consider the temporary increase in blood pressure that occurs during a process for loading and unloading goods.

In several embodiments, the fatigue calculating module 120 may calculate the fatigue of the driver by reflecting the fourth remote data as a weight to the second local data when calculating the fatigue of the driver based on the second local data. For example, when the average goods quantity or weight reference is greater than 20%, the fatigue level of the driver may be calculated as high. For another example, when the average goods quantity or weight reference is less than 20%, the fatigue level of the driver may be calculated as low.

In several embodiments, regarding calculating the fatigue of the driver, the fatigue calculating module 120 may calculate the first fatigue based on the second local data, may calculate the second fatigue based on the third remote data, and may calculate the third fatigue based on the fourth remote data, and may then calculate the highest fatigue from among the first fatigue, the second fatigue, and the third fatigue as the final fatigue.

The recommended route generating module 130 may, for example, generate a recommended route that changes the delivery route of the second remote data, e.g., goods, to induce relaxation of the driver according to the level of fatigue, such as high and low. The recommended route generating module 130 may display the recommended route on a display device in the vehicle, for example, a cluster or infotainment device.

In several embodiments, the recommended route generating module 130 may search for a resting point within a predetermined radius from the current position of the vehicle 1 when the level of fatigue is calculated to be high. When the resting point is searched, the recommended route generating module 130 may generate a recommended route by adding the searched resting point to the delivery route of the second remote data.

In several embodiments, when the level of the fatigue is calculated as high, the fatigue calculating module 120 may determine the intensity of the fatigue based on the first fatigue calculated based on the second local data, the second fatigue calculated based on the third remote data, and the fourth remote data, and the recommended route generating module 130 may generate a recommended route by varying the number of resting points according to the fatigue intensity.

In several embodiments, the recommended route generating module 130 may receive a compulsory resting instruction for instructing a resting enforcement from the remote server 30 through the communication interface 140. In this case, in response to the compulsory resting instruction, the recommended route generating module 130 may generate a recommended route regardless of the fatigue of the driver.

In several embodiments, when the level of the final fatigue is high or a compulsory resting instruction is received, the recommended route generating module 130 may not provide a new recommended route until a predetermined amount of time (e.g., 2 hours) elapses after a recommendation of resting is provided. In several embodiments, the recommended route generating module 130 may receive a satisfaction feedback of a user for the recommended route and may transmit feedback data to the remote server 30 to be managed by a database. The feedback data managed by the database may be reflected in generating the recommended routes considering resting places in the future.

According to the present embodiment, fatigue may be calculated based on the driver's biometric information and delivery information, and an appropriate delivery route considering the driver's resting may be recommended based on this, thereby reducing the risk of accidents due to overwork and supporting appropriate responses.

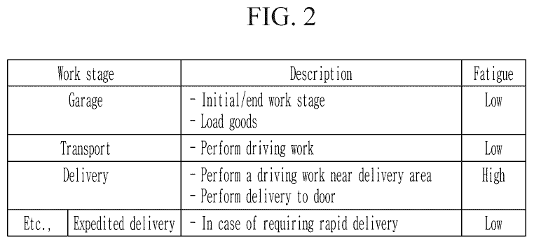

FIG. 2 shows an implemented example of a route recommending device according to an embodiment.

Referring to FIG. 2, in an implemented example of the route recommending device according to an embodiment, when calculating the fatigue of the driver based on biometric data, eye blinking capture data, and the second local data, the fatigue calculating module 120 may calculate the fatigue of the driver by reflecting the third remote data relating to the delivery stage as a weight to the second local data. That is, the fatigue calculating module 120 of may calculate the fatigue of the driver by considering influences the of fatigue at each delivery stage.

For example, when a work stage is a garage stage which is an initial/end work stage or which performs loading goods, the fatigue calculating module 120 may calculate the fatigue of the driver as low. When the work stage is a transport stage for performing a driving work, the fatigue calculating module 120 may calculate the fatigue of the driver as low. When the work stage is a delivery stage including performing a driving work near a delivery area or performing delivery to a door of the delivery address, the fatigue calculating module 120 may calculate the fatigue of the driver as high. When the work stage is an expedited delivery stage requiring a rapid delivery, the fatigue calculating module 120 may calculate the fatigue of the driver as low.

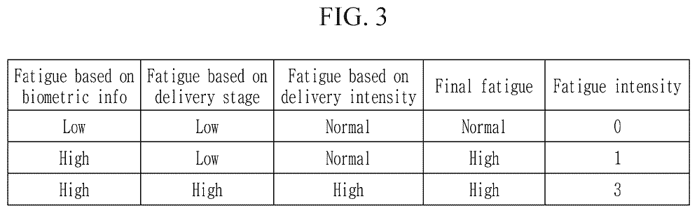

FIG. 3 shows an implemented example of a route recommending device according to an embodiment.

Referring to FIG. 3, in an implemented example of the route recommending device according to an embodiment, when calculating the fatigue of the driver, the first fatigue may be calculated based on biometric information, the second fatigue may be calculated based on the delivery stage, and the third fatigue may be calculated based on the delivery intensity, and then the highest of the first fatigue, the second fatigue, and the third fatigue may be calculated as the final fatigue.

For example, when the first fatigue is low, the second fatigue is low, and the third fatigue is normal, the final fatigue may be calculated as normal. When the first fatigue is high, the second fatigue is low, and the third fatigue is normal, the final fatigue may be calculated as high. When the first fatigue is high, the second fatigue is low, and the third fatigue is normal, and when the first fatigue is high, the second fatigue is high, and the third fatigue is high, their final fatigues may be calculated as high, but the fatigue intensities may be set differently.

That is, when the first fatigue is low, the second fatigue is low, and the third fatigue is normal, the resting route recommendation may not be performed because the final fatigue is normal. When the first fatigue is high, the second fatigue is low, and the third fatigue is normal, the final fatigue is high so a resting route is recommended, and since the fatigue intensity is 1, a resting route including one resting place may be recommended. When the first fatigue is high, the second fatigue is high, and the third fatigue is high, the final fatigue is high so a resting route may be recommended, and since the fatigue intensity is 3, the resting route including two or more resting places may be recommended.

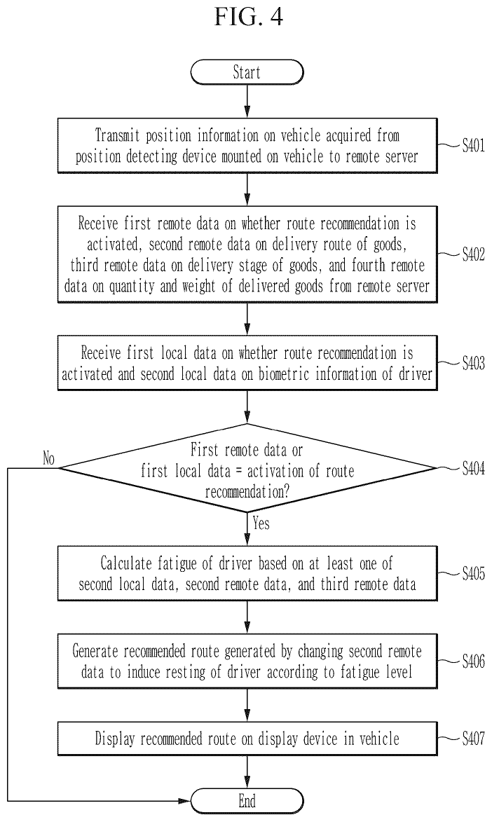

FIG. 4 shows a route recommending method according to an embodiment.

Referring to FIG. 4, the route recommending method according to an embodiment may include: transmitting position information on the vehicle acquired from the position detecting device mounted on the vehicle to a remote server (S401); receiving first remote data on whether a route recommendation is activated, second remote data on a delivery route of goods, third remote data on a delivery stage of goods, and fourth remote data on a quantity and weight of delivered goods from the remote server (S402); receiving first local data on whether a route recommendation is activated and second local data on biometric information of a driver (S403); and determining whether a value of the first remote data or the first local data indicates activation of the route recommendation (S404).

When the value of the first remote data or the first local data is determined to indicate activation of the route recommendation (‘Yes’ in S404), the method may include: calculating the fatigue of the driver based on at least one of the second local data, the second remote data, and the third remote data (S405); generating a recommended route generated by changing the second remote data to induce resting of the driver according to the level of the fatigue (S406); and displaying the recommended route on a display device in the vehicle (S407).

The description on another embodiment included in this specification may be referred to for more detailed information on the route recommending method, so repeated descriptions will be omitted.

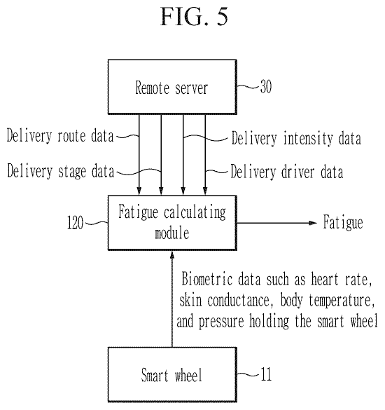

FIG. 5 shows an implemented example of a route recommending device according to an embodiment.

Referring to FIG. 5, the fatigue calculating module 120 of the route recommending device according to an embodiment may calculate the fatigue of the driver based on at least some of the delivery route data, delivery stage data, delivery intensity data, and delivery driver data provided through the remote server 30 (or the vehicle integrated controller 20, although not shown), and the biometric data such as heart rate, skin conductance, body temperature, and pressure holding the smart wheel provided from the smart wheel 11. The delivery route data may include values expressed in quantification of information on various elements relating to the delivery route, such as, for example, coordinates of the departure and destination, coordinates of intermediate stops, types of roads, expected travel time, departure and arrival times, traffic conditions, and road conditions, and the delivery stage data may include values expressed in quantification of information on various elements relating to the delivery stage, such as, for example, goods departure time, delivery vehicle information, driver information, current delivery position, current delivery status, goods arrival time, and recipient information. The delivery intensity data may include values of the quantity and weight of delivery goods, and the delivery driver data may include values of the age of the vehicle driver.

FIG. 6 shows a computing device according to an embodiment.

Referring to FIG. 6, the route recommending method and device according to embodiments may be realized using the computing device 50. The computing device 50 may be realized with various types of electronic devices, servers or devices similar to them, and its functions may be implemented by combination of software and hardware.

The computing device 50 may include at least one of a processor 510, a memory 530, a user interface input device 540, a user interface output device 550, and a storage device 560 communicating through a bus 520. The computing device 50 may include a network interface 570 electrically connected to a network 40. The network interface 570 may transmit or receive signals with other entities through the network 40.

The processor 510 may be implemented with various types of operation devices, e.g., a micro controller unit (MCU), an application processor (AP), a central processing unit (CPU), a graphic processing unit (GPU), a neural processing unit (NPU), and a quantum processing unit (QPU). The processor 510 is a semiconductor device for executing instructions stored in the memory 530 or the storage device 560, and may perform a core function of the system. The program code and data stored in the memory 530 or the storage device 560 instructs the processor 510 to perform a specific task, thereby allowing the general operation of the system. By this, the processor 510 may be configured to realize various functions and methods described in connection with FIG. 1 to FIG. 5.

The memory 530 and the storage device 560 may include various types of volatile or nonvolatile storage media for storing and approaching data of the system. For example, the memory 530 may include a read-only memory (ROM) 531 and a random access memory (RAM) 532. In several embodiments, the memory 530 may be built in the processor 510, and in this case, data transmission rates between the memory 530 and the processor 510 may be very high. In other several embodiments, the memory 530 may be disposed outside the processor 510, and is this case, the memory 530 may be connected to the processor 510 through various types of data buses or interfaces. This connection may be made through a variety of known means—for example, a peripheral component interconnect express (PCIe) interface for high-speed data transmission or a memory controller.

In several embodiments, at least some of the components or functions of the route recommending method and device according to the embodiments may be implemented as a program or software executed on the computing device 50, and the program or software may be stored on a computer-readable medium. In detail, the computer-readable recording or storing medium according to an embodiment may record a program for executing stages included in an implementation of the route recommending method and device according to embodiments, on a computer including the processor 510 executing a program or instructions stored in the memory 530 or the storage device 560.

In several embodiments, at least some of the components or functions of the route recommending method and device according to the embodiments may be implemented using hardware or circuitry of the computing device 50, or may be implemented as separate hardware or circuit that may be electrically connected to the computing device 50.

In several embodiments, at least one non-transitory computer-readable medium including instructions executable by the computing device 50 may be provided, and the instructions may allow the computing device 50 to perform operations when performed by at least one processors of the computing device 50. The operations may include configurations, functions, and stages of the route recommending method and device according to embodiments described in the present specification.

According to the embodiments, for example, the fatigue may be calculated based on biometric information and delivery information of the driver collected through the smart wheel, and may recommend the appropriate delivery route considering the resting of the driver.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A route recommending method implemented in a vehicle, and performed by a computing device including a processor and a communication interface, the route recommending method comprising:
transmitting, by the processor, position information of the vehicle obtained from a position detecting device installed in the vehicle to a remote server through the communication interface;
receiving, by the processor, first remote data on an activation state of route recommendation, second remote data on a delivery route of goods, third remote data on a delivery stage of the goods, and fourth remote data on a quantity and weight of delivery goods from the remote server through the communication interface;
receiving, by the processor, first local data on the activation state of route recommendation and second local data on biometric information of a driver through an internal network of the vehicle;
determining, by the processor, whether a value of the first remote data or the first local data indicates activation of the route recommend;
when the value of the first remote data or the first local data is determined to indicate the activation of the route recommendation, calculating, by the processor, fatigue of the driver based on at least one of the second local data, the second remote data, and the third remote data;
generating, by the processor, a recommended route obtained by changing the second remote data to induce resting of the driver according to a level of the fatigue; and
displaying, by the processor, the recommended route on a display device in the vehicle.

2. The route recommending method of claim 1, wherein:
the second local data includes biometric data measured by a smart wheel installed in the vehicle and having at least one sensor measuring the biometric information, and
the calculating of the fatigue of the driver includes calculating a fatigue level of the driver as high when a change of at least one of heart rate, skin conductance, body temperature, and pressure of grabbing the smart wheel measured by the smart wheel is greater than a first predetermined reference in the second local data.

3. The route recommending method of claim 2, wherein:
the second local data includes eye blinking capture data measured by a camera installed in the vehicle, and
the calculating of the fatigue of the driver includes calculating the fatigue level of the driver as high when a number of eye blinking measured by the camera increases to be greater than a second predetermined reference compared to an average value in the second local data.

4. The route recommending method of claim 2, further comprising:
receiving, by the processor, fifth remote data on an age of the driver of the vehicle from the remote server through the communication interface,
wherein the calculating of the fatigue of the driver includes calculating the fatigue of the driver by reflecting the fifth remote data as a weight to the second local data when calculating the fatigue of the driver based on the second local data.

5. The route recommending method of claim 2, wherein:
the calculating of the fatigue of the driver includes calculating the fatigue of the driver by reflecting the third remote data as a weight to the second local data when calculating the fatigue of the driver based on the second local data.

6. The route recommending method of claim 2, wherein:
the calculating of the fatigue of the driver includes calculating the fatigue of the driver by reflecting the fourth remote data as a weight to the second local data when calculating the fatigue of the driver based on the second local data.

7. The route recommending method of claim 2, wherein the calculating of the fatigue of the driver includes:
calculating first fatigue based on the second local data;
calculating second fatigue based on the third remote data;
calculating third fatigue based on the fourth remote data; and
calculating a highest of the first fatigue, the second fatigue, and the third fatigue as final fatigue.

8. The route recommending method of claim 1, wherein the generating of the recommended route includes:
searching for a resting point in a predetermined radius at a current position of the vehicle when a fatigue level is calculated as high; and
generating the recommended route by adding the resting point to the delivery route of the second remote data.

9. The route recommending method of claim 8, further comprising:
when the fatigue level is calculated as high, determining, by the processor, fatigue intensity based on first fatigue calculated based on the second local data, second fatigue calculated based on the third remote data, and the fourth remote data,
wherein the generating of the recommended route includes generating the recommended route by changing a number of the resting points according to the fatigue intensity.

10. The route recommending method of claim 1, further comprising:
receiving, by the processor, a compulsory resting instruction for instructing a compulsory resting from the remote server through the communication interface; and
generating, by the processor, the recommended route regardless of the fatigue of the driver in response to the compulsory resting instruction.

11. A route recommending device implemented in a vehicle comprising:
a communication interface;
at least one non-transitory computer-readable medium including instructions; and
at least one processor for executing the instructions to perform operations,
wherein execution of the instructions to perform the operations causes the at least one processor to:
transmit position information of the vehicle obtained from a position detecting device installed in the vehicle to a remote server through the communication interface;
receive first remote data on an activation state of route recommendation, second remote data on a delivery route of goods, third remote data on a delivery stage of the goods, and fourth remote data on a number and weight of the goods from the remote server through the communication interface;
receive first local data on the activation state of route recommendation and second local data on biometric information of a driver through the vehicle;
determine whether a value of the first remote data or the first local data indicates activation of route recommendation;
when the value of the first remote data or the first local data is determined to indicate the activation of the route recommendation, calculate fatigue of the driver based on at least one of the second local data, the second remote data, and the third remote data;
generate a recommended route obtained by changing the second remote data to induce resting of the driver according to a fatigue level; and
display the recommended route on a display device in the vehicle.

12. The route recommending device of claim 11, wherein:
the second local data includes biometric data measured by a smart wheel installed in the vehicle and having at least one sensor measuring the biometric information, and
to calculate the fatigue of the driver, the execution of the instructions to perform the operations further causes the at least one processor to calculate the fatigue level of the driver as high when a change of at least one of heart rate, skin conductance, body temperature, and pressure of grabbing the smart wheel measured by the smart wheel is greater than a first predetermined reference in the second local data.

13. The route recommending device of claim 12, wherein:
the second local data includes eye blinking capture data measured by a camera installed in the vehicle, and
to calculate the fatigue of the driver, the execution of the instructions to perform the operations further causes the at least one processor to calculate the fatigue level of the driver as high when a number of eye blinking measured by the camera increases to be greater than a predetermined reference compared to an average value in the second local data.

14. The route recommending device of claim 12, wherein:
the execution of the instructions to perform the operations further causes the at least one processor to receive fifth remote data on an age of the driver of the vehicle from the remote server through the communication interface, and
to calculate the fatigue of the driver, the execution of the instructions to perform the operations further causes the at least one processor to reflect the fifth remote data as a weight to the second local data when calculating the fatigue of the driver based on the second local data.

15. The route recommending device of claim 12, wherein:
the calculate the fatigue of the driver, the execution of the instructions to perform the operations further causes the at least one processor to reflect the third remote data as a weight to the second local data when calculating the fatigue of the driver based on the second local data.

16. The route recommending device of claim 12, wherein, to calculate the fatigue of the driver, the execution of the instructions to perform the operations further causes the at least one processor to:
reflect the fourth remote data as a weight to the second local data when calculating the fatigue of the driver based on the second local data.

17. The route recommending device of claim 12, wherein, to calculate the fatigue of the driver, the execution of the instructions to perform the operations further causes the at least one processor to:
calculate first fatigue based on the second local data;
calculate second fatigue based on the third remote data;
calculate third fatigue based on the fourth remote data; and
calculate a highest of the first fatigue, the second fatigue, and the third fatigue as final fatigue.

18. The route recommending device of claim 11, wherein, to generate the recommended route, the execution of the instructions to perform the operations further causes the at least one processor to:
search for a resting point in a predetermined radius at a current position of the vehicle when the fatigue level is calculated as high; and
generate the recommended route by adding the resting point to the delivery route of the second remote data.

19. The route recommending device of claim 18, wherein:
the execution of the instructions to perform the operations causes the at least one processor to, when the fatigue level is calculated as high, determine fatigue intensity based on first fatigue calculated based on the second local data, second fatigue calculated based on the third remote data, and the fourth remote data, and
to generate the recommended route, the execution of the instructions to perform the operations causes the at least one processor to change a number of the resting points according to the fatigue intensity.

20. A non-transitory computer-readable medium including instructions executable by one or more processors of a computing device including a communication interface,
wherein execution of the instructions by the one or more processors causes the one or more processors to:
transmit position information of a vehicle obtained from a position detecting device installed in the vehicle to a remote server through the communication interface;
receive first remote data on an activation state of route recommendation, second remote data on a delivery route of goods, third remote data on a delivery stage of the goods, and fourth remote data on a number and weight of delivery goods from the remote server through the communication interface;
receive first local data on the activation state of route recommendation and second local data on biometric information of a driver through an internal network of the vehicle;
determine whether a value of the first remote data or the first local data indicates activation of route recommendation;
when the value of the first remote data or the first local data is determined to indicate the activation of the route recommendation, calculate fatigue of the driver based on at least one of the second local data, the second remote data, and the third remote data;
generate a recommended route generated by changing the second remote data to induce resting of the driver according to a fatigue level; and
display the recommended route on a display device in the vehicle.
